(19) United States
(12) Patent Application Publication
(10) Pub. No.: US 2005/0112359 A1
(43) Pub. Date: May 26, 2005

(54) Lotus leaf-like self-cleaning surface structure

(76) Inventor: Ming-Theng Wang, Chung Ho City (TW)

Correspondence Address: Ming-Theng Wang, PO Box 82-144, Taipei, TW

(21) Appl. No.: 10/718,792

(22) Filed: Nov. 24, 2003

(51) Int. Cl. B32B 5/16

(52) U.S. Cl. 428/323; 428/328

(57) ABSTRACT

A self-cleaning surface structure formed of a coating mixture covered on the surface of a product, the coating mixture containing a polymeric resin and a nanometered metal oxide compound, for example, nanometered titanium dioxide, the polymeric resin serving as a medium to bond the nanometered metal oxide to the surface of the product.

### BACKGROUND OF THE INVENTION

1. Field of the Invention

The present invention relates a self-cleaning surface structure and, more particularly, to a lotus leaf-like self-cleaning surface structure that provides self-cleaning, hydrophobic, dust-proof, and anti-bacteria effects.

2. Description of the Related Art

The so-called “lotus effect” mainly means the superhydrophobicity and self-cleaning features of lotus. When rainwater dropped to the hydrophobic surface of the leaves of a lotus, it forms into water beads due to the effect of surface tension, i.e., the contact angle between the surface of the leaves of the lotus and water will be over 140°, and the water beads will roll away from the leaves when shaking the leaves. Further, rolling water beads carry dust from the surface of the leaves. Therefore, the surface of the leaves is maintained clean and dry after a heavy rain.

Through an electronic microscope, we can see that the surface of a lotus leaf has protruding epidermal cells of size about 5˜15 μm, and a wax crystal of about one nanometer covered on each epidermal cell. The chemical structure of the wax crystal is hydrophobic. When water contacted the surface of a lotus leaf, it forms into water beads due to the effect of surface tension. Due to the effect of the fine protruding epidermal cell structure, the contact area between water and the surface of the leaf is minimized and the contact angle between water and the surface of the leaf is maximized, enhancing the effect of hydrophobicity, and lowering the adhesion power of solid matter to the surface of the leaf.

Actually, the nanometered fine structure acts an important role in self-cleaning. The contact area between water beads and the surface of a lotus leaf is about 2˜3% of the total area of the leaf. When tilting the leaf, rolling water beads immediately pick up solid matter from the surface of the leaf, achieving a cleaning effect. However, rolling water beads on the hydrophobic smooth surfaces of other plants or man-made products cannot cause water beads to carry solid matter from the surfaces.

In the natural world, plants are exposed to different pollutants including dust, mud, organic bacteria, fungi, and etc. In addition to the function of self-cleaning, the fine nanometered surface structure of lotus leaves prohibits infection of bacteria and virus. Lotus leaves become clean and fresh when washed by a heavy rain.

### SUMMARY OF THE INVENTION

The present invention has been accomplished under the circumstances in view. It is the main object of the present invention to provide a self-cleaning surface structure, which has a nanometered fine surface structure similar to lotus leaves that provides hydrophobic, self-cleaning, dust-proof, and anti-bacteria features.

According to one embodiment of the present invention, the self-cleaning surface structure is formed of a coating mixture covered on the surface of a product. The coating mixture contains a polymeric resin and a nanometered metal oxide compound, for example, nanometered titanium dioxide. The polymeric resin serves as a medium to bond the nanometered metal oxide to the surface of the product. According to another embodiment of the present invention, the self-cleaning surface structure comprises a coating mixture covered on the surface of a product through a heat treatment. The coating mixture comprises a nanometered powder, for example, nanometered zinc oxide, and a nanometered metal oxide compound, for example, nanometered titanium dioxide.

### BRIEF DESCRIPTION OF THE DRAWINGS

FIG. 1 is a schematic sectional view of a lotus leaf-like self-cleaning surface structure according to the first embodiment of the present invention.

FIG. 2 is a schematic sectional view of a lotus leaf-like self-cleaning surface structure according to the second embodiment of the present invention.

### DETAILED DESCRIPTION OF THE INVENTION

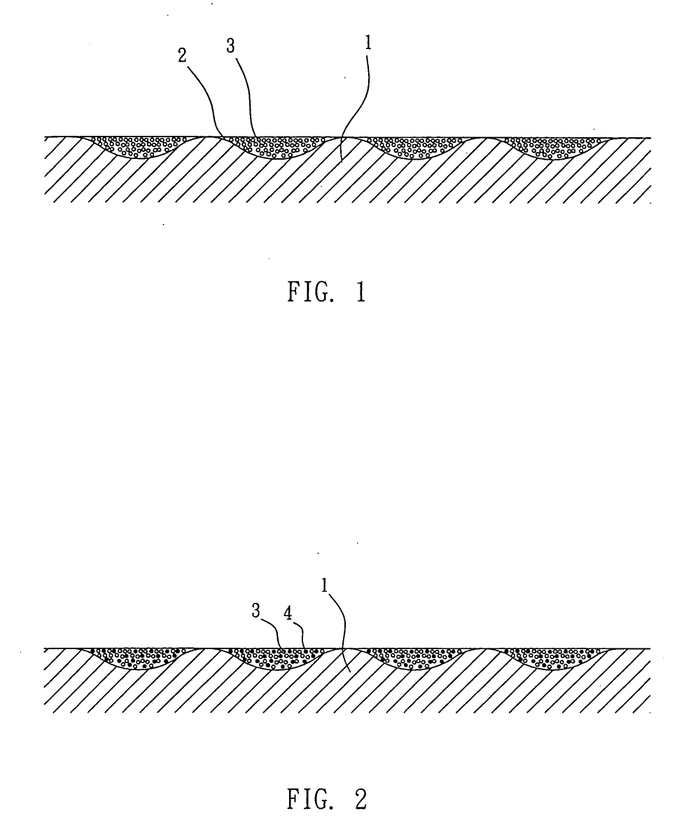

FIG. 1 is a schematic sectional view of a lotus leaf-like self-cleaning surface structure according to the first embodiment of the present invention. According to this embodiment, the lotus leaf-like self-cleaning surface structure is formed of a coating mixture containing a polymeric resin 2 and a nanometered metal oxide compound 3, and covered on the surface of a product 1 at room temperature by paining. The polymeric resin 2 serves as a bonding medium to bond the particles of the nanometered metal oxide compound 3 to the tiny recessed in the surface of the product 1, providing the desired self-cleaning and hydrophobic effects. According to this embodiment, the metal oxide compound 3 is nanometered titanium dioxide. When bonded to the surface of the product 1 by the polymeric resin 2, the metal oxide compound 3 fills up the tiny recesses on the surface of the product 1, forming a self-cleaning and hydrophobic protective layer on the surface of the product 1.

FIG. 2 is a schematic sectional view of a lotus leaf-like self-cleaning surface structure according to the second embodiment of the present invention. According to this embodiment, the lotus leaf-like self-cleaning surface structure is formed of a mixture containing a nanometered metal oxide compound, for example, nanometered titanium dioxide 3 and a nanometered powder, for example, nanometered zinc oxide powder 4. The melting point of the nanometered metal oxide compound is higher than the nanometered powder. The melting point of titanium dioxide is 1690° C. The melting point of zinc oxide is 419.5° C. When nanometered, the melting points of nanometered titanium dioxide and nanometered zinc oxide are lowered to below 200° C. When mixed together, the mixture of nanometered titanium dioxide 3 and nanometered zinc oxide powder 4 is coated on the surface of the product 1, which is heated to 200° C. Before application, nanometered titanium dioxide 3 and nanometered zinc oxide powder 4 are mixed with pure water, water wax, or an alcohol soluble solution to form a fluid mixture for coating.

If the product 1 is a ceramic or glass member, the ceramic or glass member is heated to 200° C., and then the prepared fluid mixture of nanometered titanium dioxide 3 and nanometered zinc oxide powder 4 is coated on the surface of the ceramic or glass member. After coating, the mixture fills up tiny recesses in the surface of the ceramic or glass member. When cooled down and hardened, the coating is polished, and then the coated and polished ceramic or glass member is heated to about 500˜600° C. to melt zinc oxide, causing zinc oxide to fixedly bond titanium dioxide particles to the ceramic or glass member. When finished, the ceramic or glass member has a smooth, fine, self-cleaning, hydrophobic surface structure like the surface structure of lotus leaves.

If the product 1 is a paint-coated metal plate member, the paint-coated metal plate member is heated to 150° C., and then the prepared fluid mixture of nanometered titanium dioxide 3 and nanometered zinc oxide powder 4 is coated on the surface of the paint-coated metal plate member. After coating, the mixture fills up tiny recesses in the surface of the paint-coated metal plate member. When cooled down and hardened, the coated surface is polished, and then the coated and polished paint-coated metal plate member is heated to about 200˜210° C. to melt the original paint coating, causing zinc oxide and titanium dioxide particles to be bonded to the metal surface of the metal plate member by the paint coating. When finished, the metal plate member has a smooth, fine, self-cleaning, hydrophobic surface structure like the surface structure of lotus leaves.

If the product 1 is a plastic plate member, the plastic plate member is heated to 70˜80° C., and then the prepared fluid mixture of nanometered titanium dioxide 3 and nanometered zinc oxide powder 4 is coated on the surface of the plastic plate member. After coating, the mixture fills up tiny recesses in the surface of the plastic plate member. When cooled down and hardened, the coated surface is polished, and then the coated and polished paint-coated metal plate member is heated to about 120˜150° C. to melt zinc oxide, causing zinc oxide to fixedly bond titanium dioxide particles to the plastic plate member. When finished, the plastic plate member has a smooth, fine, self-cleaning, hydrophobic surface structure like the surface structure of lotus leaves.

Although particular embodiments of the invention have been described in detail for purposes of illustration, various modifications and enhancements may be made without departing from the spirit and scope of the invention. Accordingly, the invention is not to be limited except as by the appended claims.

1. A self-cleaning surface structure comprising a coating mixture covered on the surface of a product, said coating mixture comprising a polymeric resin and a nanometered metal oxide compound, said polymeric resin serving as a medium to bond said nanometered metal oxide to the surface of said product.

2. The self-cleaning surface structure as claimed in claim 1, wherein said product is a ceramic member.

3. The self-cleaning surface structure as claimed in claim 1, wherein said product is a glass member.

4. The self-cleaning surface structure as claimed in claim 1, wherein said product is a metal member.

5. The self-cleaning surface structure as claimed in claim 1, wherein said product is a plastic member.

6. A self-cleaning surface structure comprising a coating mixture covered on the surface of a product through a heat treatment, said coating mixture comprising a nanometered powder and a nanometered metal oxide compound.

7. The self-cleaning surface structure as claimed in claim 6, wherein said product is a ceramic member.

8. The self-cleaning surface structure as claimed in claim 6, wherein said product is a glass member.

9. The self-cleaning surface structure as claimed in claim 6, wherein said product is a metal member.

10. The self-cleaning surface structure as claimed in claim 6, wherein said product is a plastic member.

11. The self-cleaning surface structure as claimed in claim 6, wherein said nanometered power is zinc oxide.

12. The self-cleaning surface st
